(19) United States
(12) Patent Application Publication
(10) Pub. No.: US 2002/0136627 A1
(43) Pub. Date: Sep. 26, 2002

(54) FORKLIFT BLADE COVER

(76) Inventor: Colin Albertyn, Chartwell Johannesburg (ZA)

Correspondence Address: Iandiorio & Teska, 260 Bear Hill Road, Waltham, MA, 02451-1018, US

(21) Appl. No.: 09/812,506

(22) Filed: Mar. 20, 2001

(51) Int. Cl. B66C 3/00

(52) U.S. Cl. 414/785

(57) ABSTRACT

A protective device for the free end of a tine of a forklift truck, in which a polymeric body is adapted to accommodate the end edge of a forklift truck tine. This protective device includes a forward end region that operatively obscures the end edge of the associated tine and a rearward extending portion that is adopted for securing the protective device to a forklift truck tine by bonding, fasteners, or in any other suitable manner.

### FIELD OF THE INVENTION

This invention relates to a forklift truck accessory and, more particularly, to a protective device for preventing, or at least diminishing, possible damage which can be caused by a forklift truck.

### BACKGROUND TO THE INVENTION

The laterally spaced pair of load bearing tines of a forklift truck usually have fairly narrow bade-like ends which may vary in thickness from 2 mm to about 15 mm.

Forklift trucks are often required to be manoeuvred in narrow isles and in other confined areas. As a result of this, and the difficulty of accurately gauging the exact location of, in particular, elevated forklift tines, it is not uncommon that damage to products on pallets, and to pallets themselves is caused by these tines.

Furthermore, in the case of smaller pallets, the tines can extend right through the pallet to project outwardly on the other side and, in such a case, the forklift truck driver has virtually no sight of the free ends of the tines and is thus not sure where they are located, thus increasing the possibility of damage to surrounding product, pallets, and even the building or storage system itself.

### OBJECT OF THE INVENTION

It is an object of this invention to provide a protective device which will assist in at least alleviating the occurrence of such damage.

### SUMMARY OF THE INVENTION

In accordance with this invention there is provided a protective device for the free end of a tine of a forklift truck, the protective device comprising a moulded polymeric body adapted to accommodate the end edge of a forklift truck tine and having a forward end region operatively obscuring the end edge of the associated tine and a rearwardly extending portion adapted for securing to a forklift truck tine by bonding, fasteners, or in any other suitable manner.

Further features of the invention provide for there to be a rearwardly extending portion on each side of the body corresponding to the operatively upper and lower major faces of the free end region of a forklift truck tine; for said portions to be defined by a deep slot or socket in the body; for the rearwardly extending portions to taper downwardly to a substantially thin rear edge; and for the operatively upper and lower faces of the body to be defined by metal plates or the like bonded or otherwise secured to the polymeric body.

Still further features of the invention provide for the protective device to be moulded from an elastomeric material such as rubber or polyurethane; for the upper and optionally also the lower surface of the body to have rearwardly extending grooves therein for minimising friction between the surface of the body and any object, in particular a pallet which it may contact; and for the colour of the device to be one associated with safety such as an eye-catching yellow or orange colour.

Clearly the overall thickness of the device must be such that it will fit easily into the space between the upper and lower platforms of a pallet without any difficulty. The forward end of the body may also be tapered to facilitate introduction thereof into the space between such upper and lower platforms.

In order that the invention may be more fully understood two different embodiments thereof will now be described with reference to the accompanying drawings.

### BRIEF DESCRIPTION OF THE DRAWINGS

In the drawings:

FIG. 1 is an oblique view of a typical pair of load bearing tines of a forklift truck illustrating, in one case, a protective device according to the invention;

FIG. 2 is a sectional side elevation of a load bearing tine end fitted with one form of protective device according to the invention;

FIG. 3 is an exploded isometric view illustrating an alternative and simplified form of the invention of greater versatility;

FIG. 4 is a plan view of the embodiment of the invention illustrated in FIG. 3 and indicating its versatility; and,

FIG. 5 is an oblique view of a tine having an alternative device according to the invention with a surface configured to decrease friction between a pallet and the body.

### DETAILED DESCRIPTION WITH REFERENCE TO THE DRAWINGS

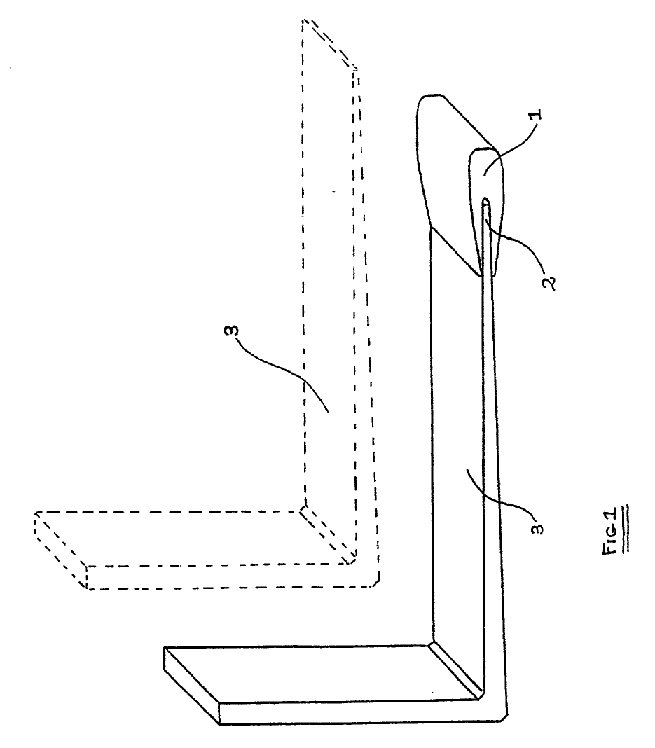

As illustrated in FIG. 1 the protective device (1) according to the invention is adapted to be fitted over the free end (2) of a load bearing tine (3) of a forklift truck.

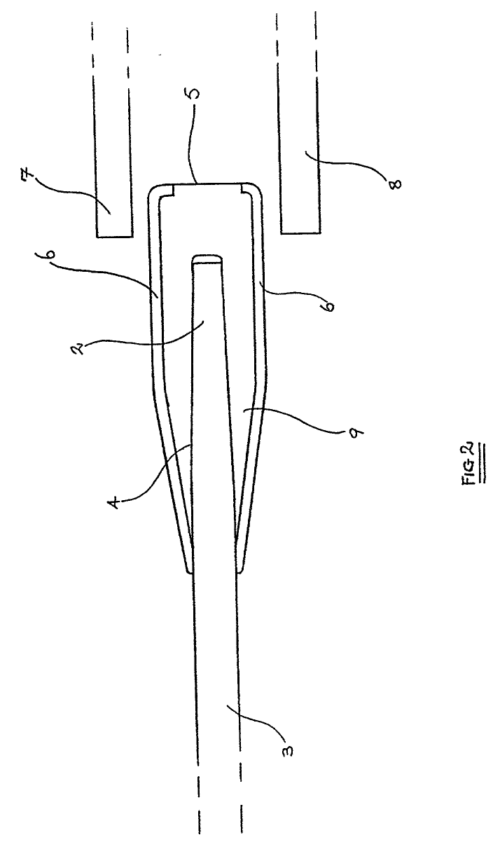

In this case the protective device has a deep socket (4) (see FIG. 2) formed therein for accommodating the end (2) of the tine. The protective device is moulded basically from a suitable rubber or polymeric material such as, for example, a suitably robust but resilient polyurethane material. The front end (5) of the device has the polymeric material exposed but the upper and lower faces of the device are defined by metal plates (6) which serve to slide against upper and lower platforms (7) and (8) of a pallet as indicated in FIG. 2.

In this embodiment of the invention the protective device is bonded to the tine end using a suitable adhesive material but it could equally well be secured in position by releasable fasteners, such as screws or bolts.

Clearly the entire height of the protective device is such that little or no difficulty will be experienced by a driver of a forklift truck in introducing the tine ends between the upper and lower platforms of a pallet.

The upper and lower faces of the device taper towards the tine's surface in a rearward position, as indicated by numeral (9), to ensure that the tine can be easily removed from a pallet without fouling same.

In use, it will be understood that the blunt, resilient forward end of the protective device will substantially prevent damage to items inadvertently engaged thereby, thus obviating the difficulties outlined above, at least to a substantial extent.

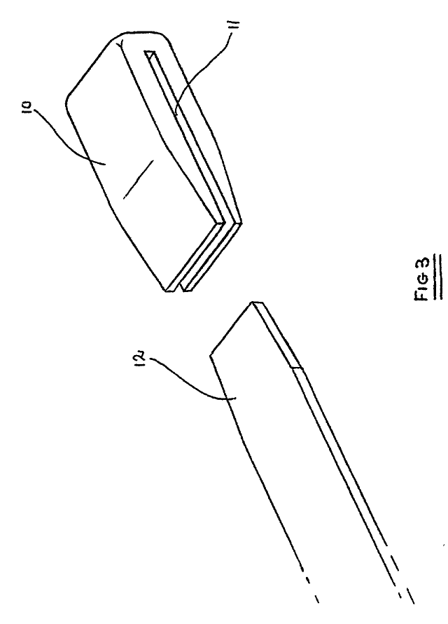

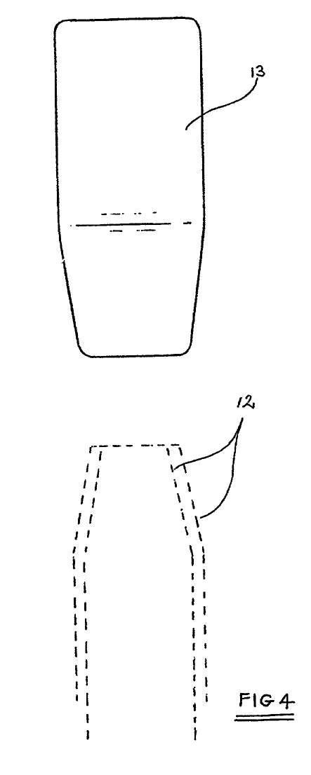

Turning now to the embodiment of the invention illustrated in FIGS. 3 and 4, a simplified version of the protective device which, in addition, has increased versatility, comprises a moulded body (10) similar to that described above but without the metal plates and having a slot (11) in place of the socket.

The provision of a slot (11) is highly advantageous in that it enables one size of protective device to be installed on a number of different sizes of forklift truck tines (12), as shown in dotted lines in FIG. 4. Also as shown in FIG. 4, the body tapers in plan view somewhat towards its rear end (13) so that, when installed on a narrower tine, there will be no projecting corners which could foul on the edges of pallets or the like, particularly when the tines are withdrawn therefrom.

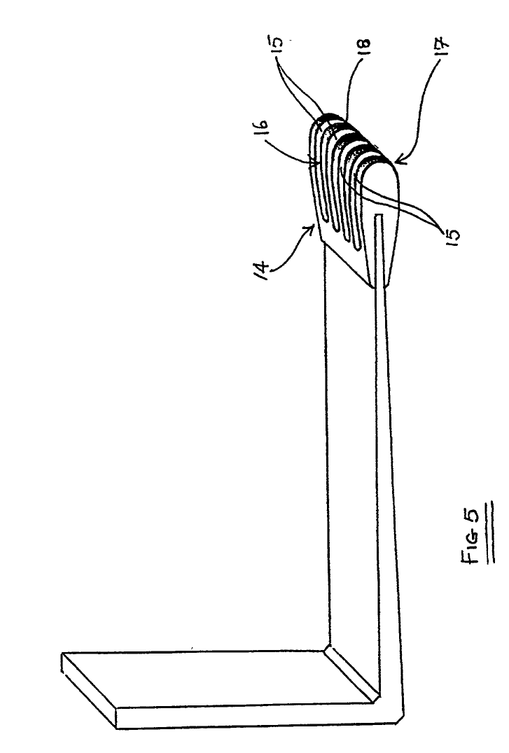

Turning now to the embodiment of the invention illustrated in FIG. 5, there is illustrated an embodiment of the invention substantially the same as is illustrated in FIG. 1 but with upper and lower surfaces configured to decrease friction between the device body and a pallet or other object which it may contact. In this case the moulded polymeric body (14) has deep rearwardly extending grooves (15) in its upper and lower surfaces (16) and (17) as well as in its front end (18). This has the effect of decreasing the area of contact between the surface, and, for example that of a pallet, with the result that there is a decrease in the tendency for the device to push, as a consequence of frictional contact, the pallet around unintentionally.

As indicated above, in either of the embodiments of the invention, the body is preferably made to an eye catching colour such as a bright yellow or orange.

Numerous variations may be made to the embodiments of the invention described above without departing from the scope hereof which is limited only to the provision of an appropriately blunt protective device for the front ends of forklift tines.

1. A protective device for the free end of a tine of a forklift truck, the protective device comprising a moulded polymeric body adapted to accommodate the end edge of a forklift truck tine and having a forward end region operatively obscuring the end edge of the associated tine and a rearwardly extending portion adapted for securing to a forklift truck tine by bonding, fasteners, or in any other suitable manner.

2. A protective device as claimed in claim 1 in which the body has a rearwardly extending portion on each side thereof corresponding to the operatively upper and lower major faces of the free end region of a forklift truck tine.

3. A protective device as claimed in claim 2 in which said rearwardly extending portions are defined by a deep slot or socket in the body.

4. A protective device as claimed in claim 1 in which the rearwardly extending portion taper downwardly to a substantially thin rear edge.

5. A protective device as claimed in claim 1 in which the operatively upper and lower faces of the body are defined by metal plates or the like bonded or otherwise secured to the polymeric body.

6. A protective device as claimed in claim 1 in which the operatively upper and lower faces of the body have rearwardly extending grooves therein.

7. A protective device as claimed in claim 1 in which the protective device is molded from an elastomeric material.

8. A protective device as claimed in claim 7 in which the elastomeric material is selected from rubber and polyurethane.

9. A protective device as claimed in claim 1 in which the color of the device is one associated with safety.

10. A protective device as claimed in claim 1 in which the rear portion of the body tapers inwardly in plan view.
